(19) United States
(12) Patent Application Publication
(10) Pub. No.: US 2024/0253855 A1
(43) Pub. Date: Aug. 1, 2024

(54) TRAY, STACK OF TRAYS AND METHOD FOR LOADING/UNLOADING TRAYS

(71) Applicant: ALPLA Werke Alwin Lehner GmbH & Co. KG, Hard (AT)

(72) Inventor: Jürgen RIEDMANN, Höchst (AT)

(73) Assignee: Alpla Werke Alwin Lehner GmbH & Co., KG, Hard (AT)

(21) Appl. No.: 18/292,450

(22) PCT Filed: Jul. 28, 2022
(86) PCT No.: PCT/EP2022/071148

§ 371 Date: Jan. 26, 2024

(30) Foreign Application Priority Data
Jul. 29, 2021 (CH) 070117/2021

(51) Int. Cl. B65D 6/24; B65D 21/02; B65G 1/02

(52) U.S. Cl. CPC B65D 11/1873; B65D 21/0213; B65G 1/026; B65G 2201/0258

(57) ABSTRACT

The invention relates to a tray (20) for storing and/or transporting goods, in particular plastic containers (10). The tray (20) comprises two first side walls (22) and two second side walls (23) and four corner elements (24). The side walls (22, 23) are connected to the corner elements (24) by way of plug connections (25). The tray (20) has a movable base (26).

The present invention relates to a tray for storing and/or transporting goods, in particular plastic containers, a stack having a plurality of trays, a method for loading trays with goods, and a method for unloading goods from trays.

For storage and transport, goods are frequently loaded into storage and transport containers, so-called trays. The trays are loaded, for example, in semi-automated or fully automated loading and unloading systems which can subsequently be arranged, for example, in a production system, for example a blowing device for plastic containers, or before a filling station.

It is generally known that available storage space is an expensive asset and therefore should be utilized in the best possible way. There is also a need to securely store the stored goods and protect them, for example, against falling over, or to protect them against excessive movement when they are transported. If, for example, the goods are packed relatively loosely, they can move a great deal and correspondingly rub against one another. Under certain circumstances, this leads to scratches on the surface of the goods.

If the goods are to be packed or at least packed in an orderly manner, more or less complicated devices may be necessary to place the goods into corresponding trays. Such a device has become known for example from WO 2017/174420 A1. Although the device disclosed in this PCT application simplifies the methods and devices known to date for loading goods into trays and also prevents the individual goods from falling over during the loading process, the device nevertheless has a relatively large number of individual parts.

It is therefore an object of the invention to eliminate at least one or more disadvantages of the prior art. In particular, a tray is to be created which makes it possible to load it with simple means and, in particular, to load it with a high packing density. Preferably, a corresponding loading method and unloading method is to be provided.

This object is achieved by the devices and methods defined in the independent claims. Further embodiments emerge from the dependent claims.

A tray according to the invention for storing and/or transporting goods, in particular plastic containers, comprises two first side walls and two second side walls. The tray also comprises four corner elements, wherein the first and second side walls are connected to the corner elements via plug connections. The tray has a movable base.

A movable base enables the tray to be loaded with goods in a higher packing density. The movable base can be raised so that it is displaced in its vertical position relative to the side walls, and therefore accessibility to the movable base is improved. Preferably, the movable base is displaced at least up to an upper end of the side walls, in particular beyond an upper end of the side walls. Goods that are placed on the raised base may, for example, be laterally grasped with a corresponding device such as a gripping unit without interference between the device and the side walls.

A free space within the fully loaded tray between the side walls and the goods for a corresponding gripping unit is therefore no longer necessary, neither for loading the goods nor for unloading the goods. The goods can be placed directly on the raised base or removed therefrom. Dropping the goods to be loaded due to a lack of space within the tray for the gripping unit can be avoided. The goods to be loaded can accordingly be introduced into the tray substantially without impact. After placing the goods to be loaded on the raised base, the latter can be lowered again. The goods placed on the raised base are correspondingly lowered together with the base and are located within the tray after lowering.

The unloading process is also facilitated and can be carried out with less harm to the materials. Typically, trays in which no additional free space is present for a gripping unit must be shaken. The goods located in the tray experience numerous shocks and can be accordingly scratched.

The movable base, on the other hand, makes it possible to lift them together with the goods so that they can be accessible from the outside and lifted off the raised base with a corresponding gripping unit. The goods therefore no longer have to be shaken but can be gripped and moved.

The gripping unit can be designed as an in particular rectangular frame, wherein said gripping unit has movable side walls which can be delivered in the direction of a center of the gripping unit.

The movable, adjustable side walls can reduce or increase a clear cross-section within the frame. As a result, the frame can be placed with a comparatively large free space above the goods to be loaded and can be moved downwards into an end position without interference with the goods. Subsequently, the movable side walls can be correspondingly supplied in the direction of the goods so that they are kept snug. It can be provided that a slight pressure is forced.

The tray can have at least two crossmembers, wherein two opposing side walls are connected to the at least two crossmembers.

The crossmembers increase the stability of the side walls. Together with the four corner elements, the first side walls and the second side walls form a frame in which the movable base is arranged. By connecting two opposite side walls to the at least two crossmembers, this frame can be stabilized.

Preferably, the movable base rests on the crossmembers. The movable base is accordingly stabilized and held by the crossmembers. Accordingly, complex devices for increasing the stability and/or stiffness of the movable base itself can be dispensed with since this can be assumed by the corresponding crossmembers.

Nevertheless, it is possible and conceivable for the movable base to have projections on its periphery for increasing the stability.

These projections can be created by bends or folds. Multiple bends are also possible.

The movable base can be made from a metallic material such as steel or aluminum and/or alloys thereof. The movable base can be designed as a metal plate, wherein the edges can be folded at the periphery thereof.

The tray can be designed in such a way that the projections of the movable base engage or can be brought into engagement in corresponding recesses in the at least two crossmembers so that the movable base can be positioned in the tray.

The movable base can accordingly be held within the tray in a defined position, and uncontrolled displacement can be prevented.

Such an embodiment additionally increases the stability of the tray.

In order to fix the first and/or second side walls, the plug connections are deformed or deformable.

After the plug connections have been joined together, they can be accordingly deformed so that an unintentional release of the plug connections is prevented.

The plug connections themselves permit easy and tool-free connection of the side walls to the corner elements.

The side walls can be made from a metallic material such as steel or aluminum and/or alloys thereof. Preferably, the side walls are made of a metal plate. The metal plate or the side walls can have bends or folds for increasing the stability.

Recesses can be provided in the crossmembers which can be brought into engagement with the first side walls of a second tray arranged below a first tray when a plurality of trays is stacked.

When a plurality of trays is stacked, they can accordingly be positioned on one another, and a stable stack of a plurality of trays can be created.

The second side walls of the tray can have a support element and a support so that the support element of a second side wall of a first tray can be arranged on the support of a second side wall of a second tray when a plurality of trays is stacked.

The secure and positionally accurate stacking of a plurality of trays on top of one another is accordingly made possible.

The support element can have guide surfaces tapering conically to one another for centering.

This facilitates the introduction or insertion of the trays one above the other and improves the positioning. Accordingly, the support can have one or more substantially complementary surfaces which can be brought into engagement or operative connection with the guide surfaces which taper conically to one another.

It is understood that supports and support elements corresponding to the first side walls can also be provided.

Another aspect of the invention relates to a stack having a plurality of trays, in particular having a plurality of trays as described herein. The stack is arranged on a frame. The frame is in engagement with the recesses in the crossmembers of a bottommost tray.

Providing a stack on a separate frame allows easy displacement, alignment, and movement of the corresponding stack.

Additionally or alternatively, it can be provided that the frame is in engagement with support elements of the second side walls of a bottommost tray.

By engaging the frame in the recesses of the crossmembers and/or in the support elements of the second side walls, precise positioning of the stack of trays arranged on the frame can be created. A secure and reliable connection between the frame and the stack of trays is produced.

The frame can be made, for example, from a metallic material, in particular stainless steel. The frame accordingly has great strength, and excessive wear is prevented.

The stack can have a cover, wherein the cover rests on corresponding supports of the second side walls of an uppermost tray.

This seals the stack of trays, and penetration of dirt can be prevented.

It is understood that the cover can also be placed on individual trays, and there does not necessarily have to be a stack of trays.

As described with respect to the second side walls of the tray, the first side walls can also have corresponding support elements and supports.

Depending on the arrangement of the crossmembers, the recesses thereof cannot be connected to the first side walls of a tray, but correspondingly to second side walls.

Another aspect of the invention relates to a method for loading trays with goods, in particular trays as described herein. The goods are preferably plastic containers. The method comprises the steps of
providing a stack of trays, in particular a stack as described herein,
removing a first tray from the stack,
providing this tray in a loading position,
lifting the movable base of the tray up to a loading level,
placing the goods to be loaded on the raised base,
lowering the raised base into its original position.

As already explained, this method enables the loading of a tray with goods without having to let them unnecessarily fall from a great height. In addition, a tray can be packed more densely by this method since no additional space has to be provided within the tray, for example to grip with a gripping unit into the tray.

Preferably, the movable base is raised in the vertical direction above the side walls of the tray.

The movable base is accordingly arranged above the side walls after being lifted and is completely accessible from the side. The goods to be loaded can accordingly be pushed basically directly to the side onto the raised base and do not necessarily have to be lifted in order to be arranged on the movable base of the tray.

The goods to be loaded are preferably placed with a gripping unit on the movable base of the tray. This allows precise and accurate loading of the tray with the goods to be loaded.

It can be provided that the gripping unit performs a complete loading of the tray in a single step, in other words places all goods to be loaded on the movable base of the tray simultaneously and in one step.

It can be provided that the gripping unit is substantially designed as a rectangular frame which encloses a packing field consisting of goods to be loaded and pushes this packing field onto the raised, movable base. The packing field can be kept full by movable side walls of the frame without clamping. Alternatively, it is also possible for the movable side walls to exert a slight pressure on the goods to be loaded.

After placing the goods to be loaded, the gripping unit is preferably opened or at least relaxed to such an extent that the goods to be loaded are no longer clamped. The gripping unit remains in this position at least during a part of the movable base lowering process.

By the gripping unit remaining in this position, a lateral guidance is provided during the lowering process, so that the goods placed on the movable base cannot fall over.

After the loading process, a second stack of loaded trays can be fed to the tray.

Before the goods to be loaded are placed on the raised base, the goods to be loaded are preferably provided in a collection position, in particular as a packing field.

A packing field corresponds to a corresponding number of goods to be loaded which corresponds to a maximum number of goods which can be placed in a single tray. A packing field is accordingly also configured according to the size of the tray, and accordingly corresponds in length and width to the corresponding dimensions of the trays to be loaded.

This allows the provision of a complete layer of goods which are placed in the tray or on the raised base.

Preferably, a plurality of goods is transferred from a feeding device to the collection position by means of a transfer device, in particular a gripper or a pusher.

By means of the corresponding transfer, a complete layer of goods can be provided so that they can be transferred by a corresponding gripping unit and placed on the raised base.

The plurality of goods can be arranged in at least one row and preferably in a plurality of rows.

An arrangement of the goods in one or more rows, or the provision of the goods in one or more rows, enables the simple transfer of the corresponding goods, for example, to a timed belt with an accumulation centering frame. By means of the timed belt, the individual rows or the plurality of rows can be shifted together in a specific direction and brought into contact with an accumulation centering frame, or in contact with already positioned goods.

As soon as a sufficient number of goods to be loaded is arranged on this accumulation centering frame, they can be measured automatically. This measurement can determine whether the packing field achieved in this way has the desired external dimensions. If this is the case, the accumulation centering frame can be removed, and the entire packing field can be moved into the collection position.

The transfer device can be designed as a gripper, in particular as a multigripper as described, for example, in WO 2017/174420 A1. A multigripper is a gripper which can simultaneously grip a plurality of containers.

Alternatively, the transfer device can also be designed merely as a pusher which makes it possible to laterally push the goods to be loaded onto a timed belt.

Another aspect of the invention relates to a method for unloading goods from trays, in particular from trays as described herein. The goods are preferably plastic containers. The method comprises the following steps:
providing a stack of loaded trays, in particular a stack as described herein,
removing a first tray from the stack,
providing this tray in an unloading position,
lifting the movable base of the tray up to an unloading plane so that the goods placed on the base to be unloaded are lifted,
removing the goods to be unloaded from the raised base,
lowering the raised base into its original position.

The lifting of the movable base for removal of the goods makes it possible to lift them against the side walls of the tray so that they protrude beyond the edge of the tray. As a result, the goods are accessible laterally and can be removed with corresponding devices without an additional space having to be provided within the tray.

The goods can be removed, for example, with a gripping unit. The gripping unit can be designed as described herein, for example as a substantially rectangular frame.

Preferably, the movable base is raised in the vertical direction above the side walls of the tray.

By raising the base above the side walls, the goods arranged or placed on the base are completely accessible laterally. For removal from the tray, and in this case for removal from the base of the tray, the goods can easily be displaced laterally. Vertical lifting can be eliminated.

Preferably, the goods to be unloaded are removed by a gripping unit from the movable base and provided in a standby position.

In this standby position, the unloaded goods can be singulated or, for example, processed further in groups such as for example in individual rows, or positioned for further processing.

To remove the goods to be unloaded from the raised base, the gripping unit is closed so that the goods to be unloaded are clamped or held snugly in the gripping unit. The gripping unit can remain in this position at least during a part of the lowering process of the base.

In the configuration of the gripping unit as a substantially rectangular frame, the frame can have movable side walls that allow a clear cross-section of the frame to be increased and decreased. In this case, the goods to be unloaded can be kept snug by the movable side walls of the frame without clamping. Alternatively, it is also possible for the movable side walls to exert a slight pressure on the goods to be unloaded.

It is also conceivable that prior to the lifting of the base, the gripping unit moves into a corresponding removal position and remains in the open state so that the gripping unit forms a lateral guide for the goods lifted with the base during the lifting of the base.

Accordingly, they are protected against falling over during the lifting process.

After the unloading process, a second stack of unloaded trays can be fed to the tray. A plurality of trays can be stacked correspondingly easily into a stack of trays so that they can again be fed together to a loading apparatus.

Following the unloading process, a plurality of goods can be transferred from the standby position to a conveyor belt by means of a transfer device, in particular a gripper or a pusher.

The goods can be accordingly fed via a conveyor belt to another processing device, such as a filling system.

The plurality of goods can be arranged in at least one row and preferably in a plurality of rows.

This allows row-by-row processing of the goods from the standby position.

Embodiments of the present invention are explained in detail below with reference to figures, which are merely schematic representations. These show:

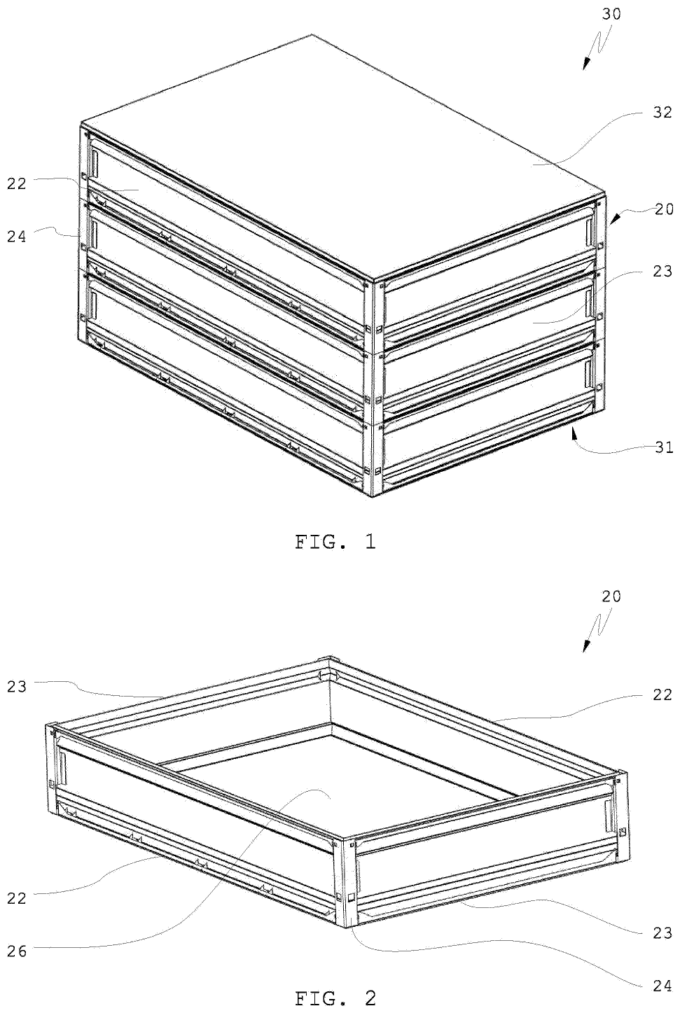

FIG. 1: a stack of trays;

FIG. 2: a single tray;

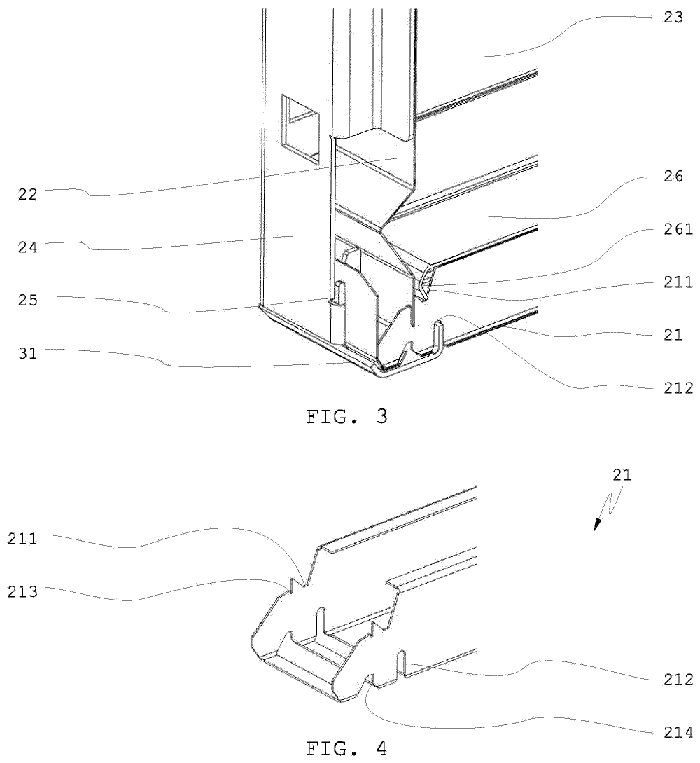

FIG. 3: a sectional view through the bottommost tray from FIG. 1;

FIG. 4: a detail view of a cross-member;

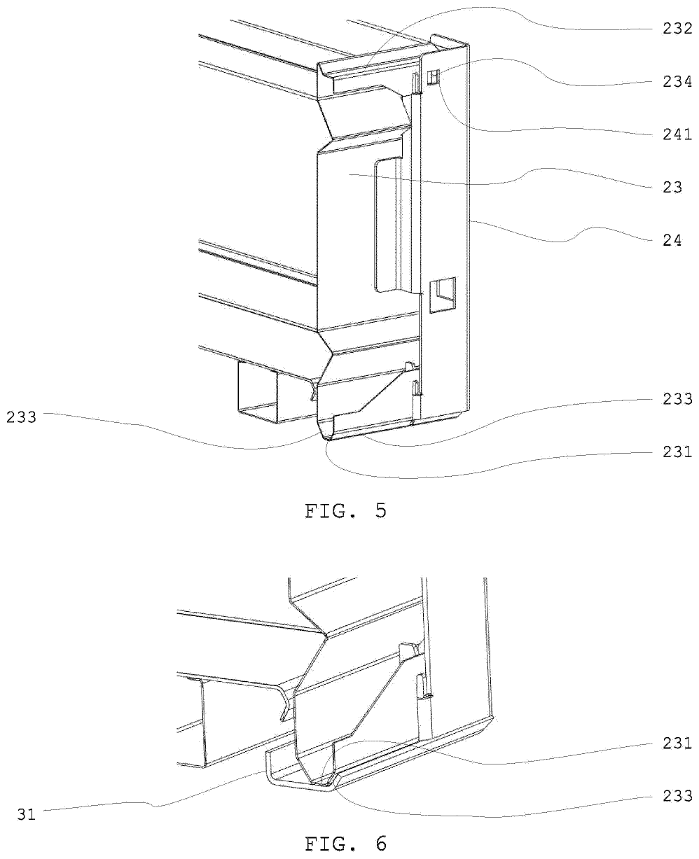

FIG. 5: a sectional view through a single tray according to FIG. 2;

FIG. 6: another sectional view through the bottommost tray of the stack according to FIG. 1;

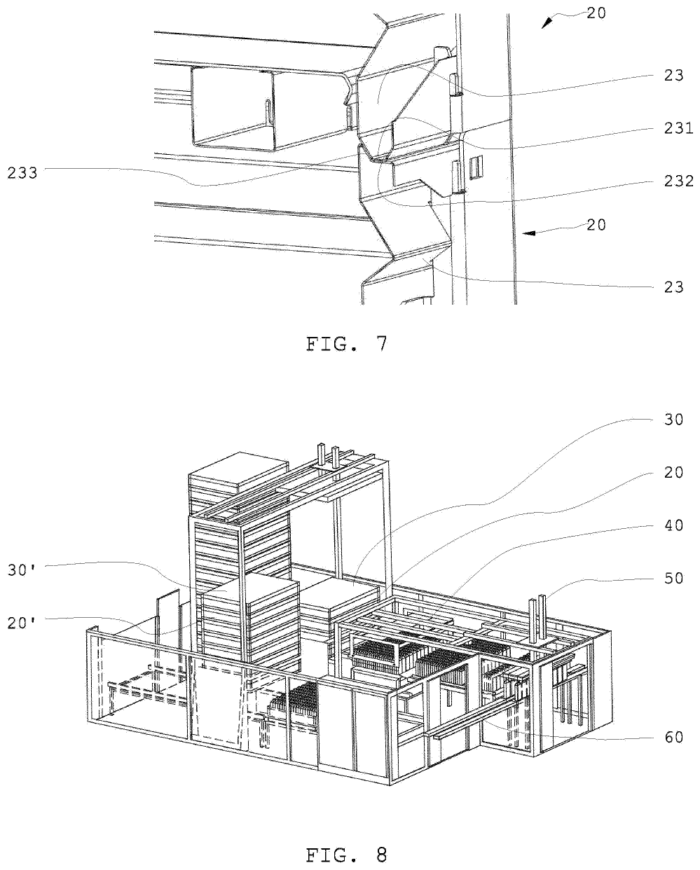

FIG. 7: a sectional view through the stack according to FIG. 1;

FIG. 8: a perspective view of a loading station;

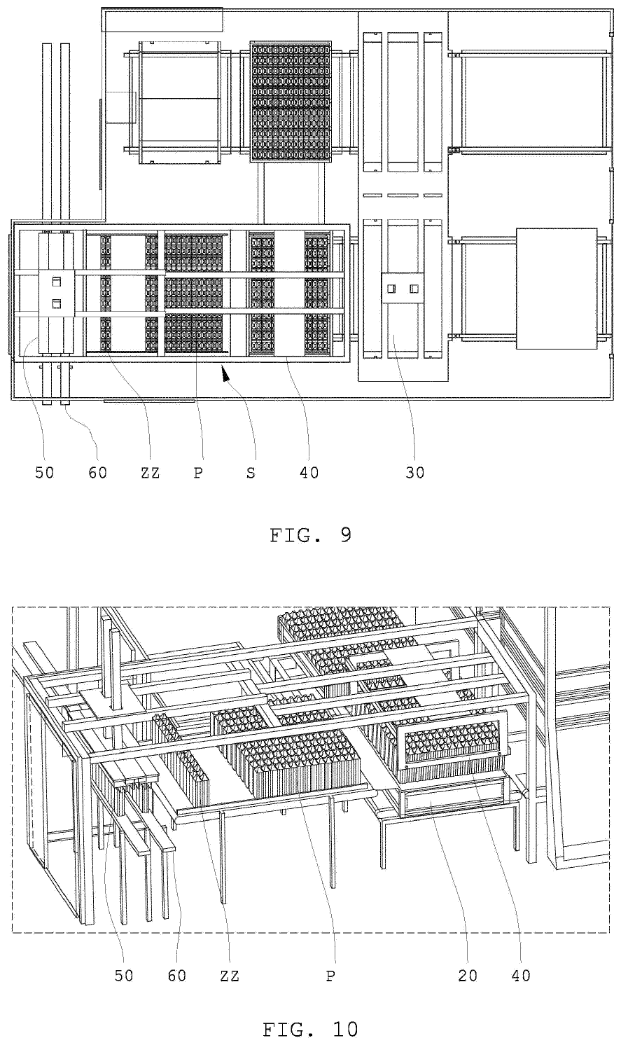

FIG. 9: a plan view of the loading station according to FIG. 8;

FIG. 10: a perspective detail view of the loading station according to FIG. 8;

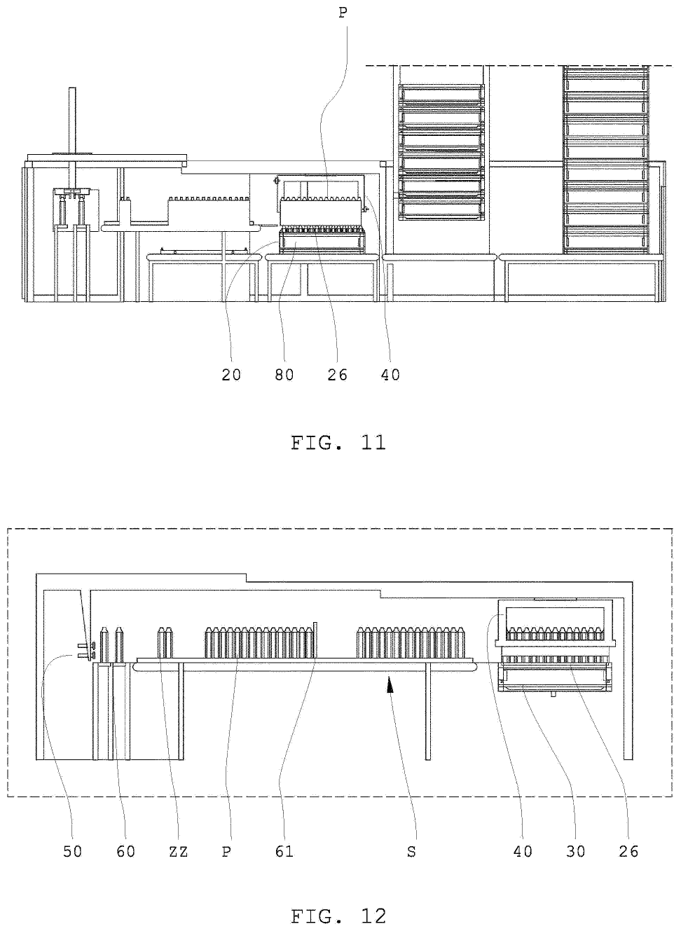

FIG. 11: a sectional view of the loading station according to FIG. 8;

FIG. 12: a side view of an alternative loading station.

FIG. 1 shows a stack 30 of trays 20. The stack 30 of trays 20 has a cover 32 with which the uppermost of the available trays 20 is sealed. The bottommost of these three trays 20 is on a frame 31. The trays 20 have first side walls 22 and second side walls 23. The side walls 22 and 23 are connected to one another via corner elements 24. For the sake of improved clarity, not all the same parts are provided with reference signs.

FIG. 2 shows a perspective view of a single tray 20. The tray 20 has two first side walls 22 and two second side walls 23. The first side walls 22 are arranged opposite one another. The second side walls 23 are also arranged opposite one another. A first side wall 22 is connected to a second side wall 23 via a corner element 24. The four side walls 22 and 23 form a frame together with the four corner elements 24. A movable base 26 is arranged within this frame.

FIG. 3 shows a sectional view through the bottommost tray 20 from FIG. 1. The sectional view extends substantially parallel to the second side wall 23. In this sectional view, the crossmember 21 is visible which is located below the movable base 26. The base 26 rests on the crossmember 21. A frame 31 on which the tray 20 is arranged is also visible.

In the present case, the base 26 is formed from a metal plate and has projections 261 on its periphery. These serve on the one hand to increase stability and, on the other hand, to position the base 26 within the tray 20.

In the present case, the projections 261 are formed by multiple bends of the metal plate.

The projections 261 engage in corresponding recesses 211 in the crossmember 21.

It goes without saying that the design of the base 26 explained herein, in particular its projections, can run around the entire periphery of the base 26.

The end of the crossmember 21 is snapped into corresponding recesses of the side wall 22.

The side wall 22 is connected to the side wall 23 via the corner element 24. Plug connections 25 are arranged in the corner element 24 and engage in corresponding openings in the side walls 22 and 23. These plug connections 25 can be deformed if necessary, so that this connection between the side walls 22 or 23 and the corner element 24 can no longer be released. In addition, an opening can be provided in the corner element 24, into which opening a corresponding mating piece of the side walls 22 or 23 can be bent. An exemplary arrangement is shown in FIG. 5. In this arrangement, a mating piece 234, which is designed as a deformable tongue, is bent into an opening 241. Vertical displacement of the corner element 24 and the side wall 23 relative to each other is prevented.

FIG. 3 also shows that the frame 31 is designed as a bent molded part and has two cheeks. One of the two cheeks engages in a cut-out 212 in the crossmember 21.

FIG. 4 shows a detail view of a crossmember 21 and, in this case, a first end of the crossmember 31. In this case, the crossmember 21 is formed as a folded molded part from a metal plate. The cut-out 212 and the recesses 211 for receiving the projections 261 of the base 26 can be seen here (see FIG. 3). The recesses 213 and 214 are provided for engagement in corresponding recesses or mating surfaces on the side wall 22 in order to snap the crossmember 21 into the side wall 22.

FIG. 5 shows a sectional view through the individual tray 20 according to FIG. 2. FIG. 5 also shows the corner element 24 with an opening 241 arranged therein into which a mating piece 234 of the side wall 23 is bent. This prevents vertical displacement of the side wall 23 and the corner element 24 relative to one another.

The section of FIG. 5 extends through the side wall 23. The side wall 23 has a support element 231 at its lower end shown here which is also located at the bottom in generic use. The support element 231 extends along the side wall 23. Guide surfaces 233 extend on both sides of the support element 231. The guide surfaces 232 have an inclination relative to the horizontal so that the guide surfaces 233 are directed toward one another.

The side wall 23 has a support 233 at its upper end shown here, which is also at the top in generic use. The support 233 extends along the side wall 23. A guide surface (not shown in greater detail) extends on one side of the support 232, in the present case in the direction of the interior of the tray 20. This guide surface has an outwardly directed inclination relative to the horizontal.

FIG. 6 shows another sectional view through the bottommost tray 20 of the stack 30 according to FIG. 1. This tray 20 is arranged on a frame 31. In particular, the tray 20 is on the frame 31 with a support element 231. A guide surface 233 is accordingly in contact with the frame 31, and in the present case with a substantially correspondingly arranged surface on the frame 31. This corresponding surface is provided by a corresponding bend in the frame 31. A corresponding design is found in all four side walls 22, 23 of the tray 20 (see FIG. 2). Accordingly, the tray 20 is centered when it is arranged on a frame 31.

FIG. 7 shows a sectional view through the stack 30 according to FIG. 1. In particular, the sectional view is shown through the interface between two trays 20 stacked one on top of the other. A first, upper tray 20 is on a second, lower tray 20. In this case, the support element 231 of a side wall 23 of the upper tray is on a corresponding support 232 of a side wall 23 of the lower tray 20. A guide surface 233 of the side wall 23 is in engagement with a corresponding guide surface, not further specified, on the support 232 of the side wall 23. A corresponding design is found in all four side walls 22, 23 of the tray 20 (see FIG. 2). Accordingly, the trays 20 are centered relative to one another when they are stacked into a stack 30.

FIG. 8 shows a perspective view of a loading station for loading trays 20 with goods. A stack 30 of trays 20 can be seen in the loading station as well as a stack 30′ of loaded trays 20′. In the loading flow upstream from the stack 30, a gripping unit 40 is visible as well as a transfer device 50 which is designed in the present case as a gripper. The feeding device 60 is shown leading into the loading station.

FIG. 9 shows a plan view of the loading station according to FIG. 8. The goods to be loaded are introduced via the feeding device 60 into the loading station, and specifically into the region below a transfer device 50. The transfer device 50 grips the goods to be loaded row-by-row and in the present case as a double row ZZ, and conveys them to a timed belt (not further specified). The timed belt transfers this double row ZZ of goods to be loaded along the loading flow in the direction of a packing field P which is in the collection position S. The packing field P is subsequently placed by the gripping unit 40 on a raised base of a tray.

FIG. 10 shows a perspective detail view of the loading station according to FIG. 8. This illustration shows that a tray 20 to be loaded is arranged in a plane that is lower in the vertical direction than the timed belt, which is not further specified, on which the packing field P is arranged.

The movable base of the tray can be raised up to a loading level. In the present case, this lies with the timed belt in one plane.

The gripping unit 40 is shown above the tray 20, clamps another packing field, and pushes it onto a corresponding base 26 (see FIG. 2).

FIG. 11 shows a sectional view of the loading station according to FIG. 8. FIG. 11 shows the lifting unit 80 with which the base 26 of the tray 20 is raised. The lifting unit 80 has a plurality of motor-driven hydraulic or pneumatic cylinders which lift the base 26. The base 26 is raised until it is substantially in the same plane as the timed belt (not further specified). This allows packing field P to be placed on the base 26 essentially by horizontal displacement.

FIG. 12 shows a side view of an alternative loading station. This is designed such that the process for loading the tray is divided into additional steps.

The goods to be loaded are introduced via the feeding device 60 into the loading station, and specifically into the region next to a transfer device 50. The feeding device 60 is designed such that two rows of goods to be loaded can simultaneously be introduced into the loading station. The transfer device 50 is designed as a pusher which pushes the goods to be loaded laterally onto a timed belt, and specifically in the form of a double row ZZ. This double row ZZ is subsequently moved in the direction of an accumulation centering frame 61 until it runs onto the accumulation centering frame 61 or onto an already existing double row ZZ of goods to be loaded. As soon as a corresponding number of goods to be loaded has accumulated on the accumulation centering frame 61, the dimension of the goods to be loaded is measured. If this corresponds to a specification, the accumulation centering frame 61 is removed, and the packing field is moved in the direction of a collection position S.

In the collection position S, the packing field P is enclosed by the gripping unit 40 and laterally displaced onto a raised base 26 of a tray 30, so that the packing field P together with the gripping unit 40 is in the position shown in FIG. 12.

FIG. 12 shows a transfer device 50 which is designed as a pusher. It is understood that a transfer device 50 as shown in FIGS. 8 to 11, which is designed as a gripper, can also be applied. It is also possible to use the pusher shown in FIG. 12 in the loading station according to FIGS. 8 to 11.

1-27. (canceled)

28. A tray (20) for storing and/or transporting goods, in particular plastic containers (10), comprising two first side walls (22) and two second side walls (23) and four corner elements (24), wherein the side walls (22, 23) are connected to the corner elements (24) via plug connections (25), wherein the tray (20) has a movable base (26).

29. The tray (20) according to claim 28, wherein the tray (20) has at least two crossmembers (21), wherein two opposing side walls (22, 23) are connected to the at least two crossmembers (21).

30. The tray (20) according to claim 29, wherein the movable base (26) rests on the crossmembers (21).

31. The tray (20) according to claim 28, wherein the movable base (26) has projections (261) on a periphery thereof for increasing stability.

32. The tray (20) according to claim 31, wherein the projections (261) can engage or be brought into engagement in corresponding recesses (211) in the at least two crossmembers (21) so that the movable base (26) can be positioned in the tray (20).

33. The tray (20) according to claim 28, wherein the plug connections (25) are deformable or deformed for fixing the first and/or the second side walls (22, 23).

34. The tray (20) according to claim 28, wherein recesses (212) are provided in the crossmembers (21) that can brought into engagement with the first side walls (22) of a second tray (20) arranged below a first tray (20) during the stacking of a plurality of trays (20).

35. The tray (20) according to claim 28, wherein the second side walls (23) of the tray (20) have a support element (231) and a support (232) so that the support element (231) of a second side wall (23) of a first tray (20) is arrangeable on the support (232) of a second side wall (23) of a second tray (20) during the stacking of a plurality of trays (20).

36. The tray (20) according to claim 35, wherein the support element (231) has guide surfaces (233) tapering conically to one another for centering.

37. A stack (30) having a plurality of trays (20) according to claim 34, wherein the stack (30) is arranged on a frame (31), wherein the frame (31) is engaged with recesses (212) of the crossmembers (21) of a bottommost tray (20).

38. The stack (30) having a plurality of trays (20) according to claim 35, wherein the stack (30) is arranged on a frame (31), wherein the frame (31) is engaged with the support elements (231) of the second side walls (23) of a bottommost tray (20).

39. The stack (30) according to claim 37, wherein the stack (30) has a cover (32), wherein the cover (32) rests on corresponding supports (232) of the second side walls (23) of an uppermost tray (20).

40. A method for loading trays (20) with goods in a stack of trays according to claim 37, the method comprising the steps of:
providing the stack of trays,
removing a first tray (20) from the stack (30),
providing this tray (20) in a loading position,
raising the movable base (26) of the tray (20) up to a loading level,
placing the goods to be loaded on the raised base (26),
lowering the raised base (26) into its original position.

41. The method according to claim 40, wherein the movable base (26) is raised in a vertical direction above the side walls (22, 23) of the tray (20).

42. The method according to claim 40, wherein the goods to be loaded are placed with a gripping unit (40) on the movable base (26) of the tray (20).

43. The method according to claim 42, wherein after the goods to be loaded are placed, the gripping unit (40) is opened, wherein the gripping unit (40) remains in this position at least during a part of the lowering process of the movable base (26).

44. The method according to claim 40, wherein the tray (20) is fed to a second stack (30′) of loaded trays (20′) after the loading process.

45. The method according to claim 40, wherein, before the goods to be loaded are placed on the raised base (30), they are provided in a collection position (S), in particular as a packing field (P).

46. The method according to claim 45, wherein a plurality of goods is transferred from a feeding device (60) into the collection position (S) by means of a transfer device (50), in particular a gripper or a pusher.

47. The method according to claim 46, wherein the plurality of goods is arranged in at least one row and preferably in a plurality of rows.

48. The method for unloading goods from trays (20) arranged in a stack of trays according to claim 37, the method comprising the steps of:
providing a stack (30′) of loaded trays (20′),
removing a first tray (20′) from the stack (30′),
providing this tray (20′) in an unloading position,
lifting the movable base (26) of the tray (20′) up to an unloading plane so that the goods placed on the base (26) to be unloaded are lifted,
removing the goods to be unloaded from the raised base (26),
lowering the raised base (26) into its original position.

49. The method according to claim 48, wherein the movable base (26) is raised in the vertical direction above the side walls (22, 23) of the tray (20).

50. The method according to claim 48, wherein the goods to be unloaded are removed by a gripping unit (40) from the movable base (26) of the tray (20) and are provided in a standby position (B).

51. The method according to claim 50, wherein the gripping unit (40) is closed to remove the goods to be unloaded from the raised base (26), so that the goods to be unloaded are clamped in the gripping unit (40), and the gripping unit (40) remains in this position at least during a part of the lowering process of the base (26).

52. The method according to any of claim 48, wherein the tray (20) is fed to a second stack (30) of unloaded trays (20) after the unloading process.

53. The method according to claim 50, wherein a plurality of goods is transferred from a standby position (B) onto a conveyor belt (70) by means of a transfer device, in particular a gripper or a pusher.

54. The method according to claim 53, wherein the plurality of goods is arranged in at least one row, and preferably in a plurality of rows.
